(19) United States
(12) Patent Application Publication
(10) Pub. No.: US 2019/0283221 A1
(43) Pub. Date: Sep. 19, 2019

(54) TWO-STAGE UNIVERSAL JOINT

(71) Applicant: YUAN LI HSING INDUSTRIAL CO., LTD., Taichung City (TW)

(72) Inventors: Hui-Chien CHEN, Taichung City (TW); Chia-Yi CHEN, Taichung City (TW)

(21) Appl. No.: 15/923,464

(22) Filed: Mar. 16, 2018

(51) Int. Cl. B25B 23/00

(52) U.S. Cl. CPC B25B 23/0014; B25B 23/0035

(57) ABSTRACT

A two-stage universal joint includes a sleeve, a driving member and an elastic member. The sleeve defines an axial direction, including a receiving room and an assembling portion. An inner wall of the receiving room has a recessed portion. The driving member includes a polygonal ball head. The polygonal ball head has a plurality of arc parts. The driving member is slidable between a first position and a second position relative to the sleeve. The polygonal ball head includes a resilient mechanism. The resilient mechanism has a tendency to normally spring radially outward.

### BACKGROUND OF THE INVENTION

### Field of the Invention

The present invention relates to a two-stage universal joint.

### Description of the Prior Art

A universal joint is a kind of hand tool which is rotatable at various angles. The universal joint includes a ball head seat and a driving lever. One end of the driving lever has a ball head which is nonrotatably and slidably disposed within the ball head seat. The driving lever is slidable between a fixed position and a swing position relative to the ball head seat. A radial projection of the driving lever is abutted against the ball head seat and is nonswingable relative to the ball head seat when the driving lever is in the fixed position. The radial projection of the driving lever is unblockable by the ball head seat and is swingable relative to the ball head seat when the driving lever is pulled outward to the swing position. As a result, the universal joint is rotatable at various angles for easy operation in a narrow workplace. However, the driving lever of the conditional universal joint cannot be effectively positioned in the desired fixed position or swing position so that the driving lever easily slides freely between the fixed position and the swing position. Therefore, the operator needs to suspend the work and adjust the driving lever to the desired position that caused inconvenience in use.

The present invention is, therefore, arisen to obviate or at least mitigate the above-mentioned disadvantages.

### SUMMARY OF THE INVENTION

The main object of the present invention is to provide a two-stage universal joint, including a sleeve and a driving member, which makes the driving member be effectively positioned in a first position or a second position. In addition, there is sufficient structural strength between the driving member and the sleeve to withstand high torque in operation.

To achieve the above and other objects, the present invention provides a two-stage universal joint, including a sleeve, a driving member and an elastic member. The sleeve defines an axial direction, having a receiving room and an assembling portion. An inner wall of the receiving room has a plurality of projections extending axially and the inner wall of the receiving room further has a recessed portion. The driving member has a polygonal ball head and the polygonal ball head has a plurality of arc parts. The polygonal ball head is inserted into the receiving room and each of the arc parts is abutted against one of the projections. The driving member is slidable between a first position and a second position relative to the sleeve. The polygonal ball head has a resilient mechanism and the resilient mechanism has a tendency to normally spring radially outward. The elastic member is disposed between the receiving room and the polygonal ball head so that the driving member has a tendency to move toward the second position. Wherein the resilient mechanism is elastically engaged with the recessed portion and the driving member is nonswingable relative to the sleeve when the driving member is in the first position; when the driving member is moved toward the second position, the resilient mechanism is disengaged from the recessed portion, the driving member is pushed by the elastic member toward the second position, and the driving member is swingable relative to the sleeve.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIGS. 1 and 2 are stereograms of a preferable embodiment of the present invention;

FIG. 3 is a breakdown drawing of a preferable embodiment of the present invention;

FIGS. 4 to 6 are sectional views of a preferable embodiment of the present invention in operation;

FIG. 7 is a stereogram of another preferable embodiment of the present invention;

FIG. 8 is a sectional view of another preferable embodiment of the present invention.

### DETAILED DESCRIPTION OF THE PREFERRED EMBODIMENTS

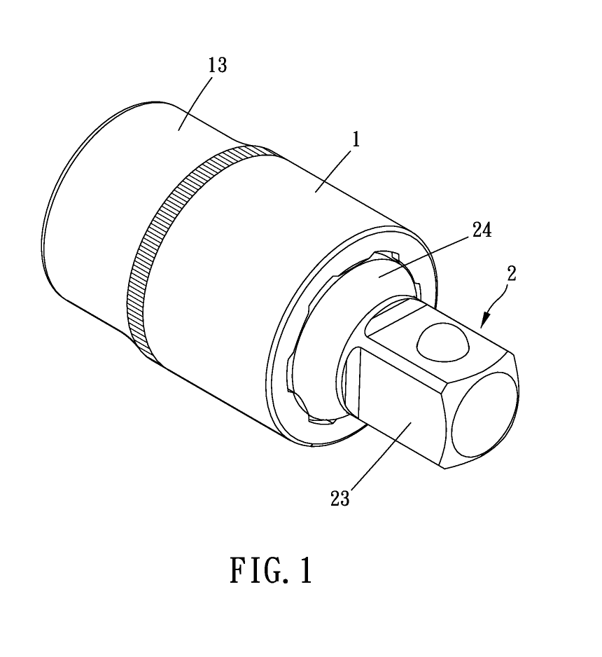

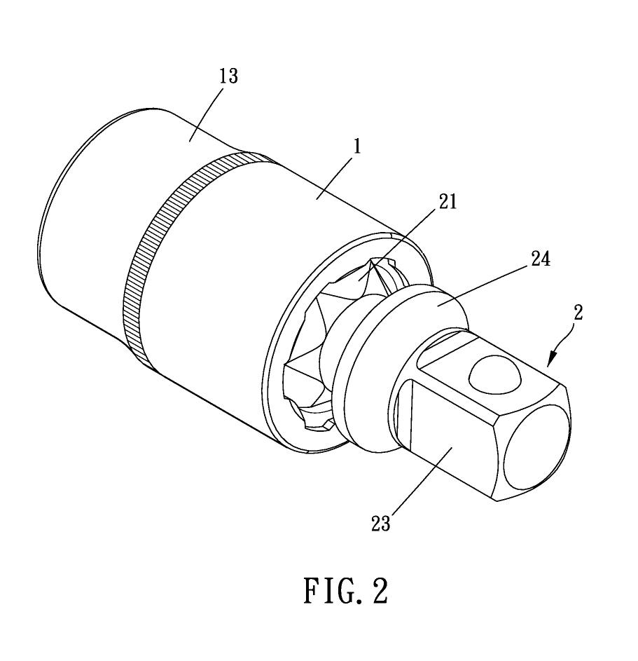

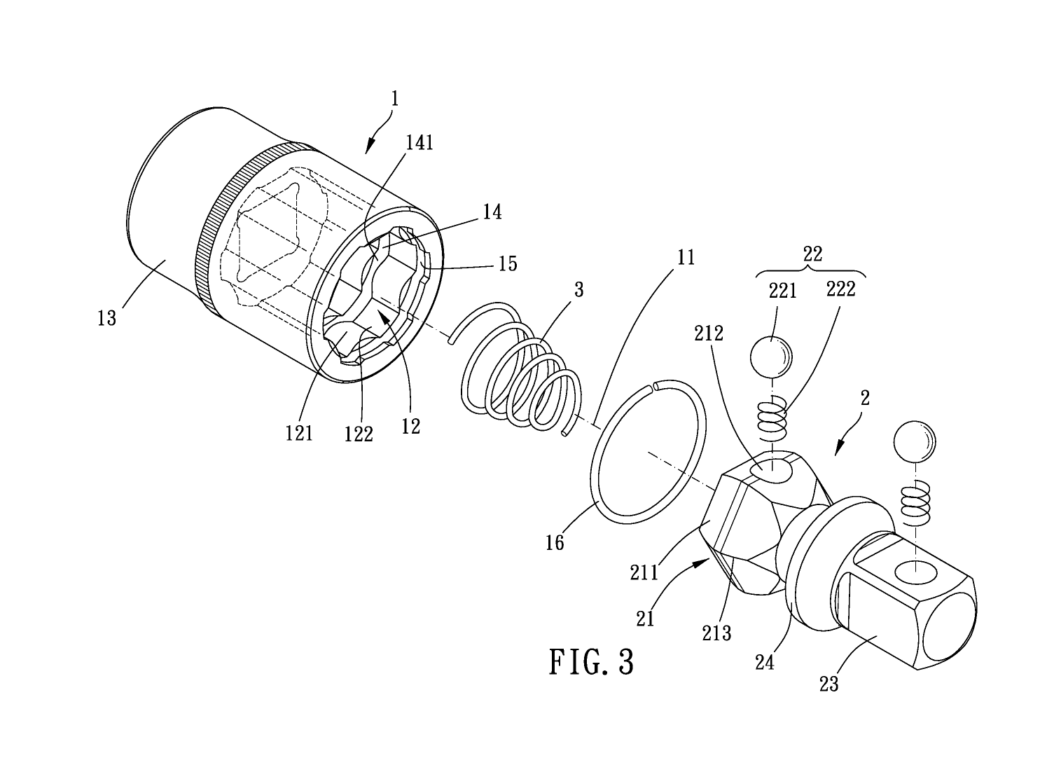

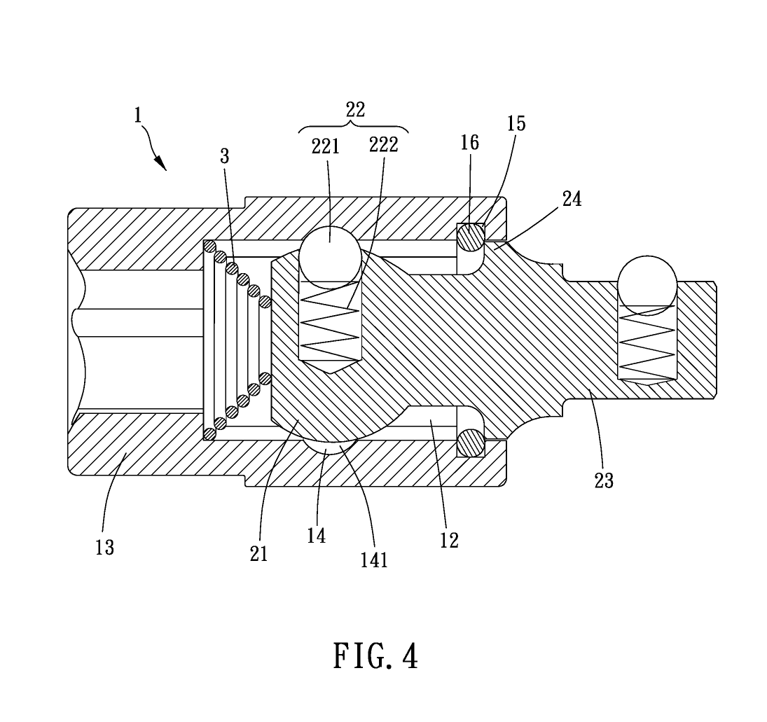

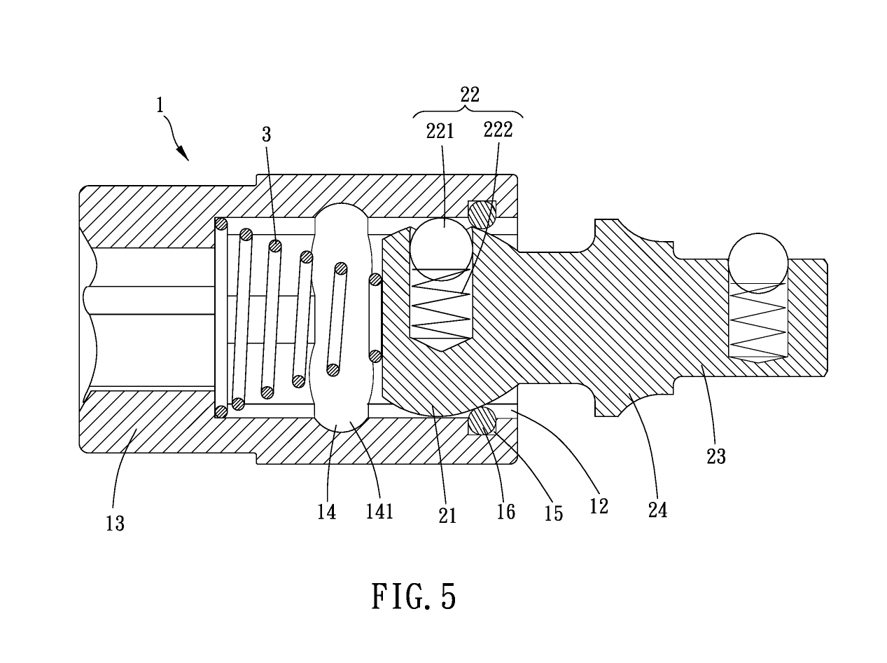

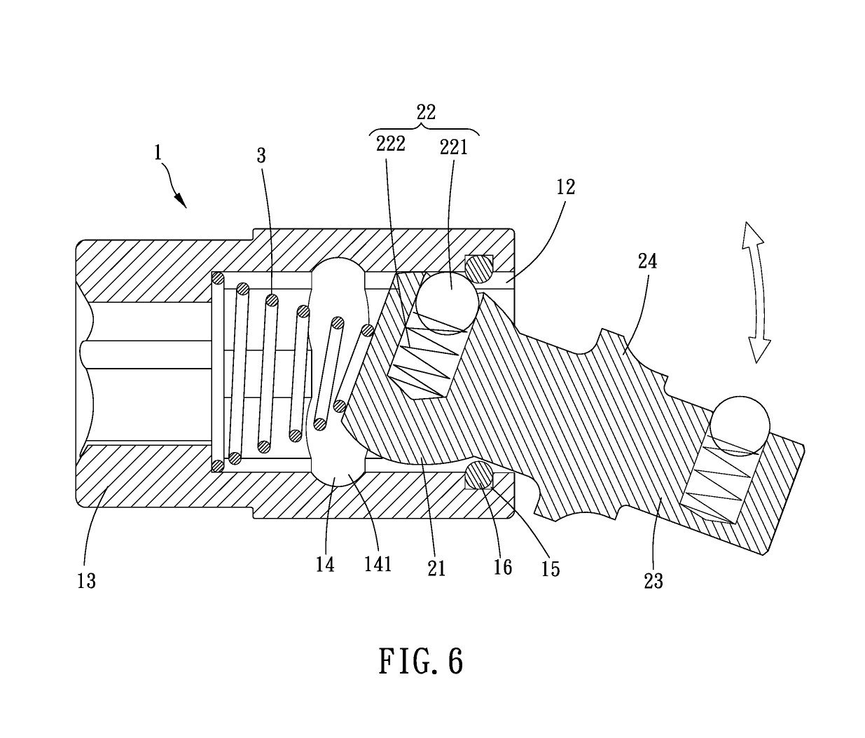

Please refer to FIGS. 1 to 6 for a preferable embodiment of the present invention. A two-stage universal joint of this invention includes a sleeve 1, a driving member 2 and an elastic member 3.

The sleeve 1 defines an axial direction 11 and has a receiving room 12 and an assembling portion 13. An inner wall of the receiving room 12 has a plurality of projections 121 extending axially, the inner wall of the receiving room 12 further having a recessed portion 14. The assembling portion 13 is configured to be assembled to a rotatable tool.

The driving member 2 has a polygonal ball head 21 and the polygonal ball head 21 has a plurality of arc parts 211. The polygonal ball head 21 is inserted into the receiving room 12 and each of the arc parts 211 is abutted against one of the projections 121. The driving member 2 is slidable between a first position and a second position relative to the sleeve 1. The polygonal ball head 21 has a resilient mechanism 22 and the resilient mechanism 22 has a tendency to normally spring radially outward.

The elastic member 3 is disposed between the receiving room 12 and the polygonal ball head 21 so that the driving member 2 has a tendency to move toward the second position.

When the driving member 2 is in the first position, the resilient mechanism 22 is elastically engaged with the recessed portion 14 and the driving member 2 is nonswingable relative to the sleeve 1, the driving member 2 is in line with the sleeve 1 and the resilient mechanism 22 is engaged with the recessed portion 14 so that the driving member 2 is not allowed to move to the second position; when the driving member 2 is moved toward the second position, the resilient mechanism 22 is disengaged from the recessed portion 14, the driving member 2 is pushed by the elastic member 3 toward the second position, the driving member 2 is swingable relative to the sleeve 1, and the sleeve 1 and the driving member 2 is rotatable at various angles. The driving member 2 may be moved toward the first position by applying an external force to overcome an elastic force of the elastic member 3, and the driving member 2 may return to the first position. Therefore, the driving member 2 can be effectively and rapidly positioned in the first position or the second position and cannot freely slide relative to the sleeve 1, thus improving convenience in use. In this embodiment, the elastic member 3 is tapered in a direction from the assembling portion 13 toward the receiving room 12 and biases on an end surface of the polygonal ball head 21 which faces the assembling portion 13.

Specifically, the resilient mechanism 22 includes an engaging member 221 and a spring 222, and the polygonal ball head 21 has a receiving hole 212. The engaging member 221 is slidably and blockably disposed within the receiving hole 212 and the spring 222 is disposed between a bottom of the receiving hole 212 and the engaging member 221 so that the engaging member 221 is normally urged outward. The engaging member 221 is preferably an engaging ball in this embodiment.

Preferably, the recessed portion 14 is a first annular groove 141 which is disposed on the inner wall of the receiving room 12. When the driving member 2 is assembled to the sleeve 1, the resilient mechanism 22 can be correspondingly received within the recessed portion 14 without further adjusting the driving member 2 and the sleeve 1 to be in a specific relative position. Preferably, a groove surface of the first annular groove 141 is an arc surface so as to effectively prevent the engaging member 221 from getting stuck by the recessed portion 14.

Specifically, the receiving room 12 further has a plurality of concaves 122 extending axially, and the projections 121 and the concaves 122 are circumferentially disposed alternatively. The first annular groove 141 extends across the projections 121 and the concaves 122. Between every adjacent two of the plurality of arc parts 211 of the polygonal ball head 21 is a corner portion 213 which is abutted against one of the plurality of concaves 122.

In this embodiment, the driving member 2 further has a working portion 23 and a radial flange 24 which are preferably integrally formed therewith. The radial flange 24 is disposed between the working portion 23 and the polygonal ball head 21 and the working portion 23 is configured to be assembled to a screwing member or a tool socket. The radial flange 24 is abutted against the inner wall of the receiving room 12 when the driving member 2 is in the first position so that the driving member 2 is nonswingable relative to the sleeve 1; the radial flange 24 is unblockable by the inner wall of the receiving room 12 when the driving member 2 is in the second position so that the driving member 2 is swingable relative to the sleeve 1.

Specifically, one end away from the assembling portion 13 of the receiving room 12 further includes a second annular groove 15 within which a blocking member 16 is detachably received. In this embodiment, the blocking member 16 is a C-shaped retainer. The blocking member 16 blocks the polygonal ball head 21 from detaching from the receiving room 12 when the driving member 2 is moved to the second position.

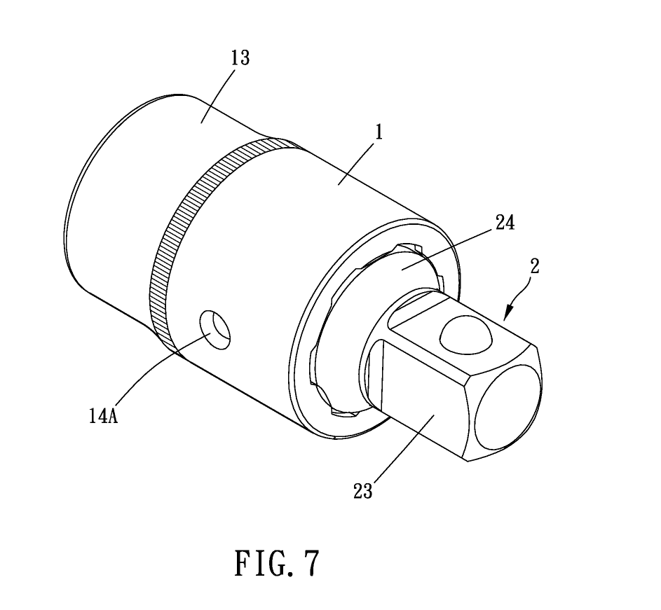

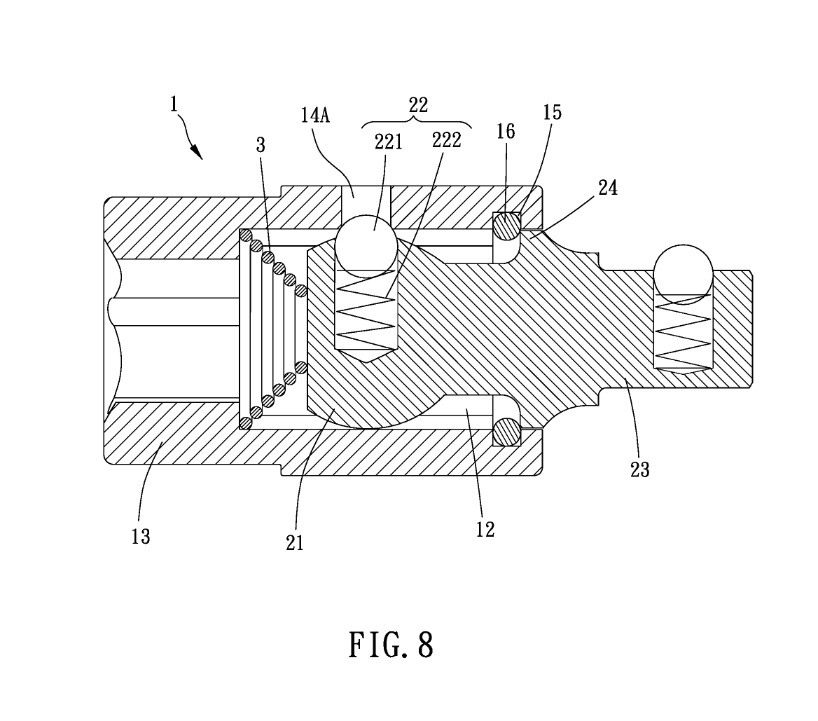

Please further refer to FIG. 7 and FIG. 8 which reveal another embodiment of this invention. The recessed portion 14A is a through hole. The engaging member 221 of the resilient mechanism 22 is elastically abutted within the through hole when the driving member 2 is in the first position so that the driving member 2 cannot be moved to the second position.

In summary, through cooperation of the elastic member, the recessed portion and the resilient mechanism, the driving member can be effectively positioned in the first position or the second position and cannot freely slide relative to the sleeve, thus improving convenience in use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A two-stage universal joint, including:
a sleeve, defining an axial direction, having a receiving room and an assembling portion, an inner wall of the receiving room having a plurality of projections extending axially, the inner wall of the receiving room further having a recessed portion;
a driving member, having a polygonal ball head, the polygonal ball head having a plurality of arc parts, the polygonal ball head being inserted into the receiving room and each of the arc parts being abutted against one of the projections, the driving member being slidable between a first position and a second position relative to the sleeve, the polygonal ball head having a resilient mechanism, the resilient mechanism having a tendency to normally spring radially outward;
an elastic member, disposed between the receiving room and the polygonal ball head so that the driving member has a tendency to move toward the second position;
wherein the resilient mechanism is elastically engaged with the recessed portion and the driving member is nonswingable relative to the sleeve when the driving member is in the first position; when the driving member is moved toward the second position, the resilient mechanism is disengaged from the recessed portion, the driving member is pushed by the elastic member toward the second position, and the driving member is swingable relative to the sleeve.

2. The two-stage universal joint of claim 1, wherein the resilient mechanism includes an engaging member and a spring, the polygonal ball head has a receiving hole, the engaging member is slidably and blockably disposed within the receiving hole, and the spring is disposed between a bottom of the receiving hole and the engaging member so that the engaging member is normally urged outward.

3. The two-stage universal joint of claim 2, wherein the recessed portion is a first annular groove which is disposed on the inner wall of the receiving room.

4. The two-stage universal joint of claim 3, wherein a groove surface of the first annular groove is an arc surface.

5. The two-stage universal joint of claim 3, wherein the receiving room further has a plurality of concaves extending axially, the projections and the concaves are circumferentially disposed alternatively, the first annular groove extends across the projections and the concaves, between every adjacent two of the plurality of arc parts of the polygonal ball head is a corner portion which is abutted against one of the plurality of concaves.

6. The two-stage universal joint of claim 1, wherein the driving member further has a working portion and a radial flange which are integrally formed therewith, the radial flange is disposed between the working portion and the polygonal ball head, the radial flange is abutted against the inner wall of the receiving room when the driving member is in the first position, and the radial flange is unblockable by the inner wall of the receiving room when the driving member is in the second position.

7. The two-stage universal joint of claim 1, wherein one end away from the assembling portion of the receiving room includes a second annular groove within which a blocking member is detachably received, the blocking member blocks the polygonal ball head from detaching from the receiving room when the driving member is moved to the second position.

8. The two-stage universal joint of claim 1, wherein the elastic member is tapered in a direction from the assembling portion toward the receiving room and biases on an end surface of the polygonal ball head which faces the assembling portion.

9. The two-stage universal joint of claim 6, wherein one end away from the assembling portion of the receiving room further includes a second annular groove within which a blocking member is detachably received, the blocking member blocks the polygonal ball head from detaching from the receiving room when the driving member is moved to the second position; the elastic member is tapered in a direction from the assembling portion toward the receiving room and biases on an end surface of the polygonal ball head which faces the assembling portion.
